(19) United States
(12) Patent Application Publication
(10) Pub. No.: US 2024/0399857 A1
(43) Pub. Date: Dec. 5, 2024

(54) VARIABLE-TYPE GRILLE APPARATUS

(71) Applicants: Hyundai Motor Company, Seoul (KR); Kia Corporation, Seoul (KR); HYUNDAI MOBIS CO., LTD., Seoul (KR)

(72) Inventors: Jin Young YOON, Gimpo-Si (KR); Dong Eun CHA, Hwaseong-Si (KR); Hong Heui LEE, Suwon-Si (KR); Jae Sup BYUN, Seongnam-Si (KR); Jang Ho KIM, Seoul (KR)

(73) Assignees: Hyundai Motor Company, Seoul (KR); Kia Corporation, Seoul (KR); HYUNDAI MOBIS CO., LTD., Seoul (KR)

(21) Appl. No.: 18/384,191

(22) Filed: Oct. 26, 2023

(30) Foreign Application Priority Data
May 31, 2023 (KR) 10-2023-0070390

(51) Int. Cl. B60K 11/08

(52) U.S. Cl. CPC B60K 11/085

(57) ABSTRACT

A variable-type grille apparatus may be configured for controlling the airflow rate passing through the grille and enhances marketability through advanced opening and closing operations during airflow rate control. That is, by diversifying the opening and closing operations of the grille including sequential operations, simultaneous operations, or the like, the opening and closing operations of the grille are advanced, the external designs are diversified, and the airflow rate is secured through an optimized structural arrangement. Furthermore, preventing jamming and malfunctions of components during opening and closing operations enhances the reliability of the opening and closing operations of the grille.

### CROSS REFERENCE TO RELATED APPLICATION

The present application claims priority to Korean Patent Application No. 10-2023-0070390, filed May 31, 2023, the entire contents of which is incorporated herein for all purposes by this reference.

### BACKGROUND OF THE PRESENT DISCLOSURE

### Field of the Present Disclosure

The present disclosure relates to a variable-type grille apparatus that is configured to control the airflow rate passing through the grille and enhances marketability through advanced opening and closing operations during airflow rate control.

### Description of Related Art

Generally, mobility requires cooling of the powertrain components and cooling system components. Accordingly, a grille is formed in the mobility to allow air to flow through the front portion to cool the powertrain and cooling system components.

In other words, during the mobility operation, the vehicle-induced airflow introduced through the grille passes through the powertrain components and cooling system components to cool each component through air and heat exchanges.

On the other hand, the powertrain and cooling system components of mobility need to reach a temperature in a certain range to be driven at optimal performance. However, the grille of the mobility is always open so that the powertrain and cooling system components exchange heat with the outside air. In other words, the inflow of air may adversely affect power and fuel efficiency until the temperature of the powertrain components reaches a certain range during initial start-up. In addition, an excessive increase in vehicle-induced airflow rate during high-speed driving of the mobility may increase air resistance and cause a decrease in fuel efficiency.

To address these issues, mobility is recently provided with active air flaps. These active air flaps are provided on the grille and configured to open or close so that air inflow is blocked when the flaps are closed and air is allowed to enter through the grille when the flaps are open.

However, conventional active air flaps are configured so that a plurality of doors rotate through a complex linkage structure. As a result, the active air flaps become more complex in structure, increase weight, and require larger motors to operate the plurality of doors and the linkage structure.

In addition, the conventional active air flaps simply perform the role of selectively controlling the flow of air.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a variable-type grille apparatus that is configured to control the airflow rate passing through the grille and enhances marketability through advanced opening and closing operations during airflow rate control.

According to an exemplary embodiment of the present disclosure for achieving the object described above, a variable-type grille apparatus may include a housing with a guide hole extending to include a straight section and mounted to a drive motor, an opening and closing portion provided to be movable along the guide hole in the housing, coupled a guide link, and rotating when the guide link moves linearly, and a rotation portion including a rotation shaft connected to the drive motor and a rotation plate coupled to the rotation shaft, wherein a guide portion connected to the guide link is formed in the rotation plate and the guide portion is included in an operable range based on the connection point of the guide link.

The guide portion may be formed as a groove in the rotation plate, and the guide link includes a protrusion inserted into the guide portion to move along the guide portion.

The guide portion may extend from an external side to an internal side of the rotation plate.

An outermost part of the guide portion in the rotation plate may be open to outside thereof.

The operable range may be a range within a predetermined angle on first and second sides of a second reference line orthogonal to a first reference line which represents a direction of a linear movement of the guide link.

The predetermined angle may be set to 45° with respect to the second reference line, so that the operable range is set by 90°.

The opening and closing portion may include a moving shaft portion to which a panel portion is coupled, and the moving shaft portion may include a first connecting portion to which the guide link is rotatably connected and a second connecting portion inserted into the guide hole.

The second connecting portion may be formed at first and second end portions of the moving shaft portion to bend backward from the moving shaft portion so that a connecting position between the first connecting portion and the guide link and an insertion position of the second connecting portion into the guide hole are apart from each other in a front-to-rear direction thereof.

The second connecting portion may include a moving portion that linearly aligns with a connecting part between the first connecting portion and the guide link and a tilting guide portion that bends backward from the moving portion to be inserted into the guide hole.

Guide holes may be formed in the upper portion and the lower portion of the housing respectively, and a first portion and a second portion spaced from the first portion outward are provided in the upper and lower portions, while the guide hole may include a first guide hole that extends in a front-to-rear direction in the first portion and into which the moving portion is inserted and a second guide hole that forms a moving path in the second portion and into which a tilting guide portion inserted.

The guide hole may extend straight from the front toward the rear and then bends diagonally.

The guide hole may extend diagonally from the front toward the rear and then extends straight.

The guide hole may extend diagonally from the front toward the rear.

The housing may include a plurality of guide holes provided in a row, a plurality of opening and closing portions are respectively connected to the guide holes, and the rotation portion includes a plurality of rotation plates respectively connected to the guide links of the opening and closing portions.

A single rotation shaft may be coupled to the plurality of rotation plates by passing through the plurality of plates in the rotation portion, so that the plurality of rotation plates simultaneously rotates when the drive motor operates.

The plurality of rotation plates may be formed so that the respective guide portions include the same start and end positions but have different shapes.

The plurality of rotation plates may be formed so that the respective guide portions include the same start and end positions but the size gradually decreases or increases overall.

In the variable-type grille apparatus including the structure described above, the airflow rate passing through the grille may be controlled and the marketability may be enhanced through advanced opening and closing operations during airflow rate control.

In other words, by diversifying the opening and closing operations of the grille including a sequential operation, a simultaneous operation, and the like, the opening and closing operations of the grille may be advanced, the external designs may be diversified, and the airflow rate may be secured through the optimized structural arrangement.

Furthermore, preventing jamming and malfunctions of components during the opening and closing operations enhances the reliability of the opening and closing operations of the grille.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a variable-type grille apparatus according to an exemplary embodiment of the present disclosure.

FIG. 2 is an disassembly view of the variable-type grille apparatus illustrated in FIG. 1.

FIG. 3 is a view exemplarily illustrating a guide link and a rotation portion of the variable-type grille apparatus illustrated in FIG. 1.

FIG. 4 is a view exemplarily illustrating a start position state of a guide link and a rotation portion.

FIG. 5 is a view exemplarily illustrating an operating state of a guide link and a rotation portion.

FIG. 6 is a view for describing an operable range of a rotation portion.

FIG. 7 is a view exemplarily illustrating a connection structure of a housing and an opening and closing portion.

FIG. 8 is a view exemplarily illustrating a start position of an opening and closing portion in a connection structure of a housing and the opening and closing portion.

FIG. 9 is a top view exemplarily illustrating a start position of an opening and closing portion in a connection structure of a housing and the opening and closing portion.

FIG. 10 is a view exemplarily illustrating an operating state of an opening and closing portion in a connection structure of a housing and the opening and closing portion.

FIG. 11 is a top view exemplarily illustrating an operating state of an opening and closing portion in a connection structure of a housing and the opening and closing portion.

FIG. 12 is a view exemplarily illustrating an exemplary embodiment of a guide hole according to an exemplary embodiment of the present disclosure.

FIG. 13 is a view exemplarily illustrating another exemplary embodiment of a guide hole according to an exemplary embodiment of the present disclosure.

FIG. 14 is a view exemplarily illustrating various exemplary embodiments of a guide hole according to an exemplary embodiment of the present disclosure.

FIG. 15 is a view exemplarily illustrating a guide portion of a rotation plate according to an exemplary embodiment of the present disclosure.

FIG. 16 is a view for describing a guide portion of a rotation plate according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The exemplary embodiments included herein will be described in detail with reference to the accompanying drawings. However, the same or similar components will be provided the same reference numerals regardless of the drawing numbers, and the repetitive descriptions regarding these components will be omitted.

The suffixes “module” and “unit” for the components used in the following description are provided or interchangeably used only to facilitate the writing of the specification, without necessarily indicating a distinct meaning or role of their own.

When it is determined that the specific description of the related and already known technology may obscure the essence of the exemplary embodiments included herein, the specific description will be omitted. Furthermore, it is to be understood that the accompanying drawings are only intended to facilitate understanding of the exemplary embodiments included herein and are not intended to limit the technical ideas included herein are not limited to the accompanying drawings and include all the modifications, equivalents, or substitutions within the spirit and technical scope of the present disclosure.

The terms including ordinal numbers such as first, second, and the like may be used to describe various components, but the components are not to be limited by the terms. The terms may only be used for distinguishing one component from another.

It is to be understood that when a component is referred to as being “connected” or “coupled” to another component, the component may be directly connected or coupled to the another component, but other components may be interposed therebetween. In contrast, it is to be understood that when a component is referred to as being “directly connected” or “directly coupled” to another component, no other component is interposed therebetween.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

Furthermore, a unit or a control unit included in the names such as a motor control unit (MCU), a hybrid control unit (HCU), and the like is a term widely used in the naming of controllers that control specific functions of a vehicle and does not mean a generic function unit.

A variable-type grille apparatus according to an exemplary embodiment of the present disclosure will be described below with reference to the accompanying drawings.

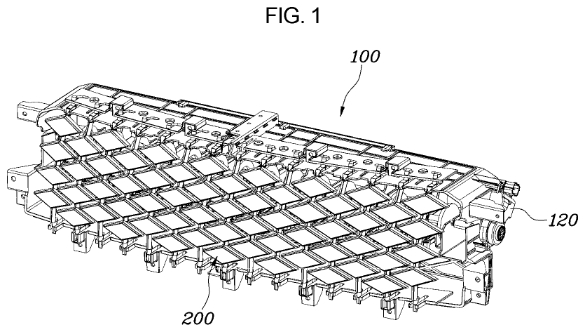

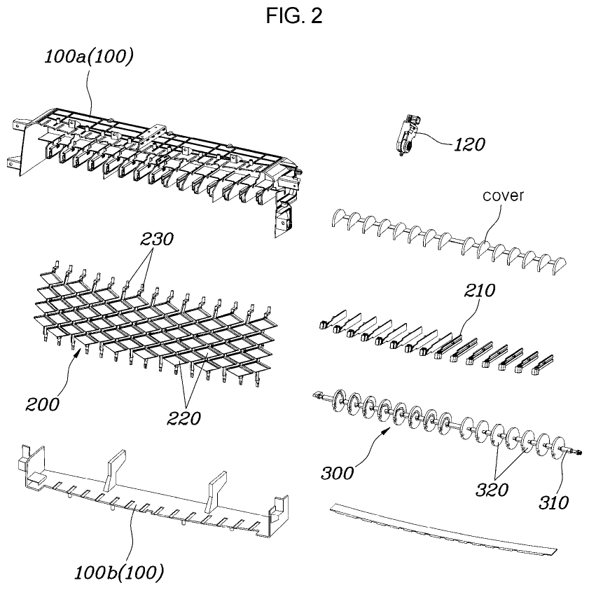

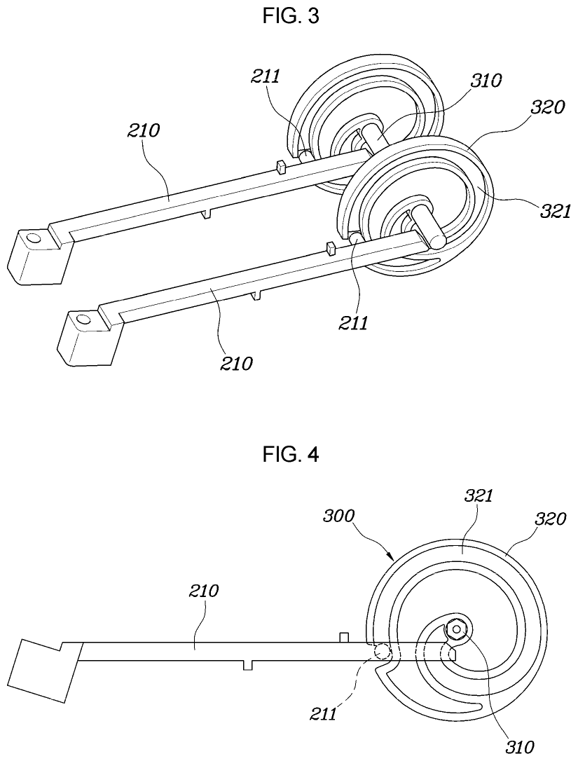

As illustrated in FIG. 1, FIG. 2, and FIG. 3, a variable-type grille apparatus according to an exemplary embodiment of the present disclosure includes a housing 100 that includes a guide hole 110 including an open space in the front-to-rear direction and extending to include a straight section and is provided with a drive motor 120, an opening and closing portion 200 provided to be movable along the guide hole 110 in the housing 100, provided with a guide link 210, and rotating when the guide link 210 moves linearly, and a rotation portion 300 including a rotation shaft 310 connected to the drive motor 120 and a rotation plate 320 coupled to the rotation shaft 310, wherein a guide portion 321 connected to the guide link 210 is formed in the rotation plate 320 and the guide portion 321 extends from the external side to the internal side of the rotation plate 320 but is included in an operable range R based on a connection point of the guide link 210.

The housing 100 is provided in the front portion of the mobility and may include a grille. The housing 100 includes a space which is open in the front-to-rear direction to allow airflow and the powertrain components or electrical components may be cooled by the air flowing through the open space. Furthermore, the housing 100 is divided into upper and lower portions to facilitate assembly.

The housing 100 is provided with the drive motor 120 and the opening and closing portion 200, and the opening and closing portion 200 is movably and rotatably provided so that the space which is open in the front-to-rear direction is selectively opened or closed according to the movement and rotation position of the opening and closing portion 200.

The opening and closing positions of the opening and closing portion 200 are controlled by operation of the drive motor 120, and the opening and closing portion 200 and the drive motor 120 are connected to each other through the rotation portion 300. The rotation portion 300 includes the rotation shaft 310 connected to the drive motor 120 and the rotation plate 320 coupled to the rotation shaft 310, and the guide portion 321 connected to the guide link 210 is formed in the rotation plate 320. The guide portion 321 of the rotation plate 320 extends from the external side to the internal side of the rotation plate 320 so that the guide link 210 may move linearly while moving along the shape of the guide portion 321 when the rotation plate 320 rotates. At the instant time, the opening and closing portion 200 rotates while moving along a moving path following the shape of the guide hole 110 of the housing 100 so that the opening and closing positions are controlled. Here, the drive motor 120 may be operated by a control command received through a motor controller.

The guide portion 321 includes a groove, and a protrusion 211 inserted into the guide portion 321 to move along with the guide portion 321 is formed in the guide link 210 so that the guide link 210 may be connected to the rotation plate 320 to move according to the shape of the guide portion 321.

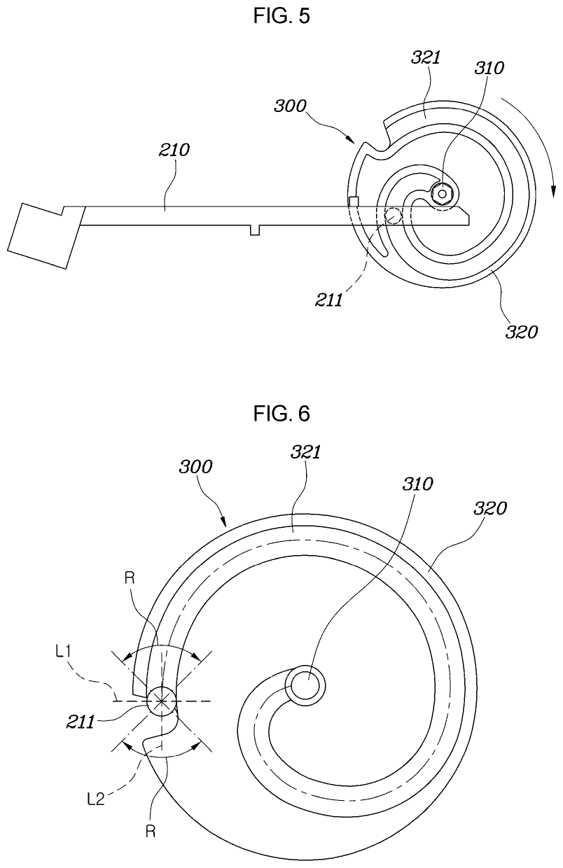

As illustrated in FIG. 3, FIG. 4, and FIG. 5, the guide portion 321 extends in the rotation direction in the rotation plate 320 and is formed in a shape curving from the external side to the internal side toward the center. As a result, when the rotation plate 320 rotates, the guide link 210 moves from the external side to the internal side of the rotation plate 320 according to the extending shape of the guide portion 321. In other words, the guide link 210 moves linearly by the rotating movement of the rotation plate 320 so that the opening and closing portion 200 connected to the guide link 210 is pulled backward or pushed forward thereof. As a result, the opening and closing portion 200 moves in the front-to-rear direction according to the rotation position of the rotation plate 320 while rotating along the moving path following the guide hole 110 of the housing 100 to open or close the open space of the housing 100.

Furthermore, the outermost portion of the guide portion 321 in the rotation plate 320 may be open to the outside thereof, which allows the protrusion 211 to enter the guide portion 321 in the rotation plate 320 through the portion open to the outside when the guide link 210 is connected to the rotation plate 320 and the protrusion 211 may be positioned to be surrounded by the guide portion 321 when the rotation plate 320 rotates. As a result, the connection of the guide link 210 to the rotation plate 320 is facilitated, and the guide link 210 may move linearly by the rotating movement of the rotation plate 320 while the protrusion 211 of the guide link 210 is connected to the guide portion 321 of the rotation plate 320.

According to an exemplary embodiment of the present disclosure, the guide portion 321 of the rotation plate 320 is included in the operable range R based on the connection point of the guide link 210.

This is to ensure that the protrusion 211 of the guide link 210 may move smoothly along the trajectory of the guide portion 321 when the rotation plate 320 rotates while the protrusion 211 of the guide link 210 is inserted into the guide portion 321. The guide portion 321 of the rotation plate 320 is included in the operable range R based on the protrusion 211 which is the connection point of the guide link 210. The present operable range R may be set so that the protrusion 211 of the guide link 210 smoothly moves along the trajectory of the guide portion 321 and avoids jamming when the rotation plate 320 rotates.

As illustrated in FIG. 6, the operable range R may be set to a range within a predetermined angle on both sides of the second reference line L2 orthogonal to the first reference line L1 which represents the direction of linear movement of the guide link 210.

In an exemplary embodiment of the present disclosure, the rotation plate 320 rotates along with the rotation shaft 310 when the drive motor 120 operates, and the guide link 210 is connected to the guide portion 321 of the rotation plate 320 to move linearly.

However, according to an exemplary embodiment of the present disclosure, the opening and closing positions, the opening and closing speed, and the opening and closing timing of the opening and closing portion 200 are controlled as the guide link 210 moves linearly. Accordingly, the guide portion 321 may extend in various directions in the rotation plate 320. If a section with an excessively sharp bending is set, the protrusion 211 of the guide link 210 may be stuck and cannot move along the guide portion 321. In other words, if the path of the guide portion 321 for the linear movement of the guide link 210 during the rotation of the rotation plate 320 is incorrectly set, the guide link 210 may not move properly due to errors such as jamming.

Accordingly, the first reference line L1 which represents the direction of the linear movement of the guide link 210 is set, and the second reference line L2 which represents the direction perpendicular to the first reference line L1 is set. In other words, the first reference line L1 may represent the direction of the linear movement of the guide link 210 during the rotation of the rotation plate 320, and the second reference line L2 may represent the direction in which the protrusion 211 of the guide link 210 moves along the guide portion 321 during the rotation of the rotation plate 320. Here, the range within the predetermined angle on both sides of the second reference line L2 is set to be the operable range. As the predetermined angle is set to 45° with respect to the second reference line L2, the operable range R may be set by 90°. As a result, the path of the rotating movement of the rotation plate 320 and the path of the guide portion 321 are within the range of 90° so that the guide link 210 may smoothly move in the guide portion 321.

When the operable range R is set in the present manner and the guide portion 321 is set to deviate from the operable range R in the rotation plate 320, the path of the rotating movement of the rotation plate 320 and the direction in which a force is applied to the guide portion 321 as the rotation plate 320 rotates differ from each other so that the protrusion 211 of the guide link 210 may be pressed against the guide portion 321 to cause jamming.

Therefore, according to an exemplary embodiment of the present disclosure, the rotation plate 320 is formed such that the guide portion 321 extends in the operable range R so that the protrusion 211 of the guide link 210 smoothly moves along the guide portion 321 to be linked to the rotating movement of the rotation plate 320, allowing the linear movement of the guide link 210.

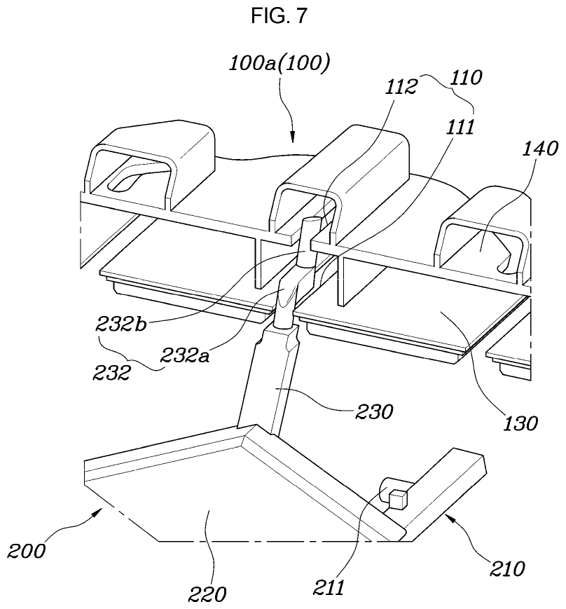

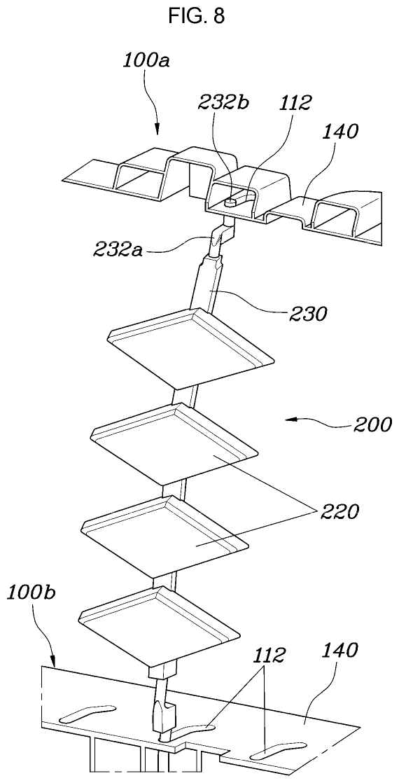

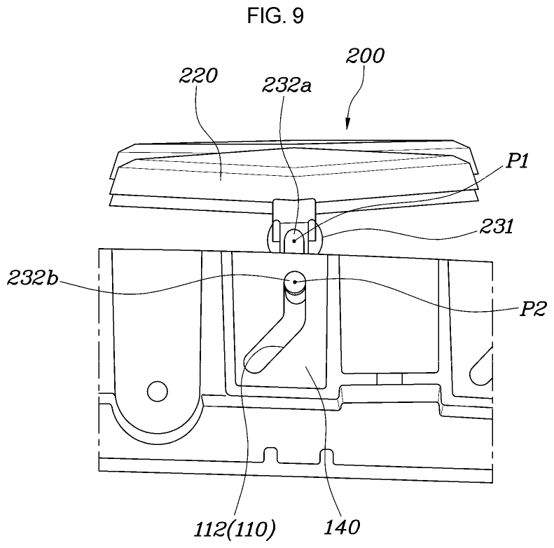

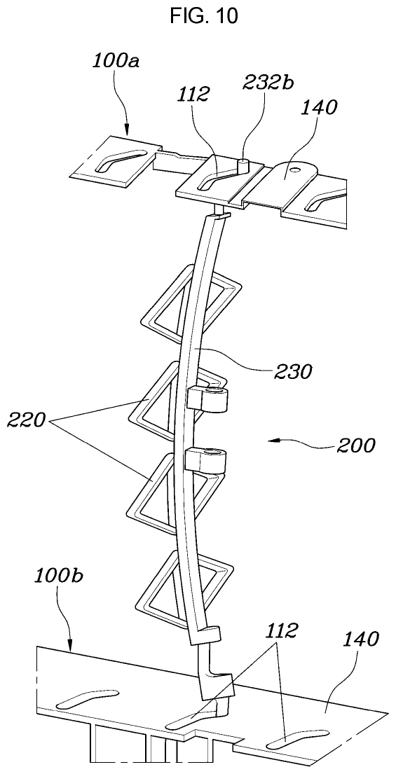

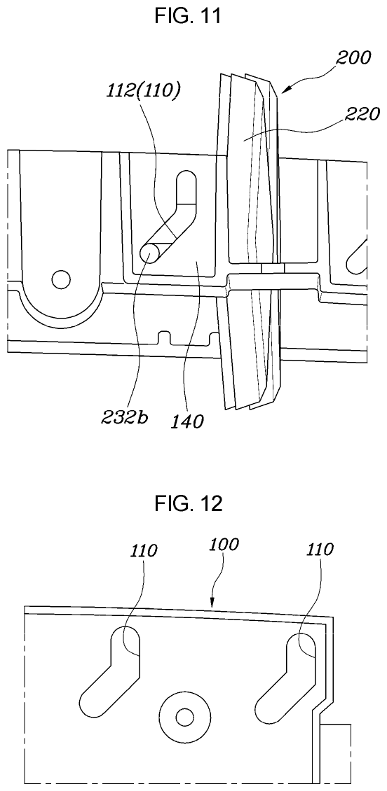

On the other hand, as illustrated in FIG. 7, FIG. 8, FIG. 9, FIG. 10, and FIG. 11, the opening and closing portion 200 includes a moving shaft portion 230 to which a panel portion 220 is coupled, and a first connecting portion 231 to which the guide link 210 is rotatably connected and a second connecting portion 232 inserted into the guide hole 110 may be formed in the moving shaft portion 230.

The panel portion 220 may include a certain area to close the open space of the housing 100 and may be formed in various shapes.

Furthermore, a plurality of panel portions 220 may be formed and arranged along the moving shaft portion 230. According to an exemplary embodiment of the present disclosure, diamond-shaped panel portions 220 are arranged along the moving shaft portion 230, and different panel portions 220 of the opening and closing portion 200 are disposed to partially overlap in the up-and-down direction thereof.

The first connecting portion 231 and the second connecting portion 232 are formed in the moving shaft portion 230. The guide link 210 is rotatably connected to the first connecting portion 231 in a hinge structure, and the second connecting portion 232 extends upward or downward to be inserted in the guide hole 110.

Here, since the first connecting portion 231 and the guide link 210 are connected so that the rotation shaft 310 is formed in the up-and-down direction, the panel portion 220 may open or close the open space of the housing 100 while rotating in a lateral direction.

The second connection portion 232 is formed at both end portions of the moving shaft portion 230 to bend backward from the moving shaft portion 230 so that the connecting position between the first connecting portion 231 and the guide link 210 and the insertion position of the second connecting portion 232 inserted into the guide hole 110 are apart from each other in the front-to-rear direction.

The first connecting portion 231 and the second connecting portion 232 are apart from each other in the front-to-rear direction in the moving shaft portion 230 in the present manner so that a support force is secured to ensure that the moving shaft portion 230 does not rotate along with the panel portion 220 when an external force is applied and rotates only by the guide link 210 moving linearly in conjunction with the rotation of the rotation plate 320 by operation of the drive motor 120.

In other words, the moving shaft portion 230 to which the panel portion 220 is coupled includes the first connecting portion 231 to which the guide link 210 is connected and the second connecting portion 232 inserted into the guide hole 110 so that a rotation axis P1 where the first connecting portion 231 and the guide link 210 are connected and a guide axis P2 which is the position of the second connecting portion 232 inserted into the guide hole 110 are separated. Here, when the rotation axis P1 and the guide axis P2 align with each other, a small load may cause rotation when an external force is applied to the panel portion 220. Therefore, because the first connecting portion 231 and the second connecting portion 232 are apart from each other in the front-to-rear direction in the moving shaft portion 230, a support force may be secured against an external force by disposing the rotation axis P1 and the guide axis P2 at a distance and the smooth rotating movement may be performed by the linear movement of the guide link 210.

On the other hand, the second connecting portion 232 may include a moving portion 232a linearly aligning with the connecting portion between the first connecting portion 231 and the guide link 210 and a tilting guide portion 232b bending backward from the moving portion 232a to be inserted into the guide hole 110.

The guide holes 110 are formed in the upper portion 100a and the lower portion 100b respectively in the housing 100, the upper portion 100a and the lower portion 100b are provided with a first portion 130 and a second portion 140 spaced from a first guide outward, and the guide hole 110 may include a first guide hole 111 extending in the front-to-rear direction in the first portion 130 to be inserted in the moving portion 232a and a second guide hole 112 forming a moving path in the second portion 140 for the tilting guide portion 232b to be inserted thereinto.

In other words, the first portion 130 and the second portion 140 are formed in the upper portion 100a and the lower portion 100b of the housing 100 respectively to build a multi-layered structure. Here, the first guide hole 111 extending in the front-to-rear direction to guide the movement of the moving portion 232a is formed in the first portion 130, and the second guide hole 112 extending to form a moving path and guide the movement of the tilting guide portion 232b is formed in the second portion 140.

As a result, the moving portion 232a of the moving shaft portion 230 is movably inserted into the first guide hole 111 so that twisting of the shaft of the moving shaft portion 230 is prevented and the linear movement is stabilized. The tilting guide portion 232b of the moving shaft portion 230 bends backward from the moving portion 232a to be movably inserted into the second guide hole 112 and moves along the moving path formed by the second guide hole 112. In other words, the tilting guide portion 232b of the moving shaft portion 230 bends backward from the moving portion 232a so that the shaft of the moving shaft portion 230 and the shaft of the tilting guide portion 232b are disposed apart from each other so that the tilting guide portion 232b may rotate around the shaft of the moving shaft portion 230.

As a result, the moving portion 232a moves only linearly in the first guide hole 111 and the panel portion 220 moves along with the moving shaft portion 230, and the tilting guide portion 232b performs tilting movement while moving along the second guide hole 112 so that the panel portion 220 may tilt by the rotation of the moving shaft portion 230.

On the other hand, the guide hole 110 may implement various tilting movements of the opening and closing portion 200 according to the shape of the moving path.

In an exemplary embodiment of the present disclosure, as illustrated in FIG. 12, the guide hole 110 may extend linearly from the front toward the rear and then bend diagonally.

As a result, the rotation plate 320 rotates when the drive motor 120 operates, and when the guide link 210 moves linearly by the rotation of the rotation plate 320, the opening and closing portion 200 moves backward and then rotates along the diagonally bent shape to implement an opening operation of the space in the housing 100.

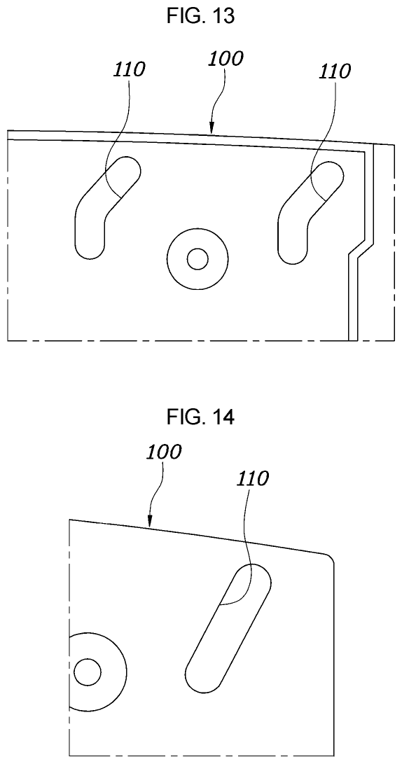

In another exemplary embodiment of the present disclosure, as illustrated in FIG. 13, the guide hole 110 may diagonally extend from the front toward the rear and then extend linearly.

As a result, the rotation plate 320 rotates when the drive motor 120 operates, and when the guide link 210 moves linearly by the rotation of the rotation plate 320, the opening and closing portion 200 rotates and then moves backward to implement the opening operation of the space in the housing 100.

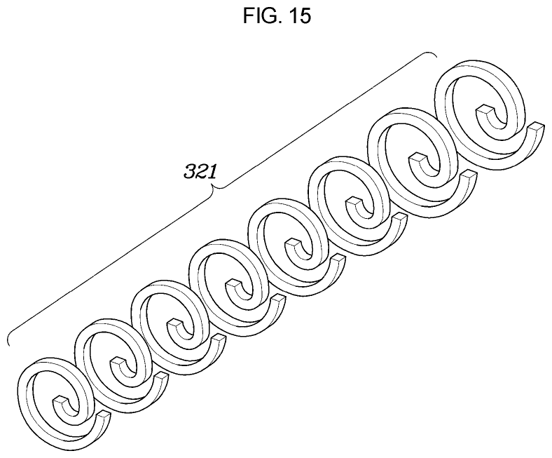

In various exemplary embodiments of the present disclosure, as illustrated in FIG. 14, the guide hole 110 may diagonally extend from the front to the rear.

As a result, the rotation plate 320 rotates when the drive motor 120 operates, and when the guide link 210 moves linearly by the rotation of the rotation plate 320, the opening and closing portion 200 moves backward and rotates simultaneously to implement the opening operation of the space in the housing 100. Furthermore, when the guide hole 110 diagonally extends long and gently bends diagonally, the rotation operation of the opening and closing portion 200 may be performed slowly compared to other embodiments described above.

The opening and closing operation and the opening and closing speed of the opening and closing portion 200 may be diversified according to the shape of the guide hole 110 in the present manner, and various embodiments besides the exemplary embodiments described above may apply. However, the opening and closing portion 200 needs to rotate 90° to switch to the open or close state, and the guide hole 110 may have various shapes on the condition that the start positions of the opening and closing portion 200 and the final positions after moving are the same.

On the other hand, a plurality of guide holes 110 are provided in the housing 100, a plurality of opening and closing portions 200 are connected to respective guide holes 110, and the rotation portion 300 includes a plurality of rotation plates 320 to which the guide link 210 of the respective opening and closing portions 200 may be connected.

A plurality of opening and closing portions 200 are provided and a plurality of rotation plates 320 of the rotation portions 300 and guide holes 110 of the housing 100 to control the opening and closing position of the opening and closing portions 200 are formed in the present manner so that the open space of the housing 100 may be opened or closed through the plurality of opening and closing portions 200. Furthermore, the plurality of opening and closing portions 200 allows diversified designs of the respective panel portions 220 forming the opening and closing portion 200 and facilities the securing of the support rigidity of the opening and closing portion 200.

Here, a single rotation shaft 310 is coupled to a plurality of rotation plates 320 by passing through the plurality of plates 320 in the rotation portion 300, so that the plurality of rotation plates 320 may simultaneously rotate when the drive motor 120 operates. As a result, a single drive motor 120 and a single rotation shaft 310 may simultaneously rotate the plurality of rotation plates 320 in the rotation portion 300. Furthermore, the plurality of rotation plates 320 is coupled to the single rotation shaft 310, the respective rotation plates 320 to which the plurality of opening and closing portions 200 are connected are connected to each other through the rotation shaft 310 to provide mutual support therebetween.

On the other hand, according to an exemplary embodiment of the present disclosure, the plurality of rotation plates 320 may be formed so that the guide portions 321 include the same start and end positions but have different shapes.

In an exemplary embodiment of the present disclosure, the guide portion 321 of the rotation plate 320 is for guiding the movement of the guide link 210, and the shape of the guide portion 321 is configured to determine the moving distance or moving speed of the guide link 210.

Accordingly, the opening and closing timing of the opening and closing portion 200 may be diversified by forming the respective guide portions 321 of the plurality of rotation plates 320 in different shapes.

However, the plurality of rotation plates 320 are formed so that the respective guide portions 321 include the same start and end positions so that the start positions and the end positions of the guide links 210 connected to respective rotation plates 320 are aligned to ensure that the opening or closing positions of the opening and closing portions 200 are the same. In other words, if the opening or closing positions of the opening and closing portions 200 are different from each other, assembly defects and poor appearance may result when the opening and closing portions 200 are viewed from outside thereof. Accordingly, the plurality of rotation plates 320 may have different shapes for the respective guide portions 321 and diversify the opening and closing speed of the opening and closing portions 200, but the opening or closing positions of the opening and closing portions 200 are aligned to ensure that the marketability does not deteriorate.

In an exemplary embodiment to the present end, the plurality of rotation plates 320 may be formed so that the respective guide portions 321 include the same start and end positions but the size may gradually decrease or increase overall.

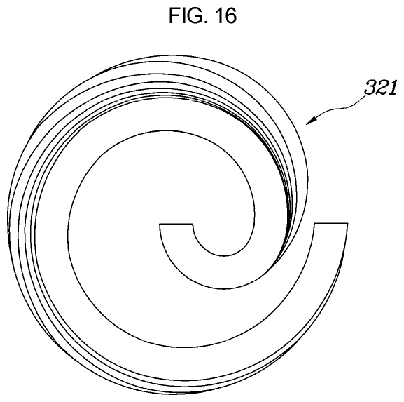

As illustrated in FIG. 15 and FIG. 16, when the guide portion 321 of the respective rotation plates 320 is formed so that the size gradually increases in the direction in which the plurality of rotation plates 320 are arranged, the moving speed of the guide link 210 slows down in order of increasing size of the guide portions 321 when the respective rotation plates 320 rotate. As a result, the plurality of opening and closing portions 200 may perform sequential opening and closing operations as the guide links 210 sequentially move linearly according to the shape of the guide portion 321 of the respective rotation plates 320.

As described above, in an exemplary embodiment of the present disclosure, the opening and closing portions 200 are provided in the open space of the housing 100 to open or close the open space, and the rotation direction and speed are controlled according to the shape of the guide hole 110 of the housing 100 and the opening and closing speed of the opening and closing portion 200 is controlled by the shape of the guide portion 321 of the rotation plate 320 in the opening and closing portion 200, so that the opening or closing operation of the respective opening and closing portions 200 may be diversified, external designed may be improved, and the marketability may be enhanced through the advanced opening and closing operations of the opening and closing portion 200 when a plurality of opening and closing portions 200 are provided.

In the variable-type grille apparatus including the structure described above, the airflow rate passing through the grille is controlled and the marketability is enhanced through advanced opening and closing operations during airflow rate control.

In other words, by diversifying the opening and closing operations of the grille such as a sequential operation, a simultaneous operation, or the like of the grille, the opening and closing operations of the grille are advanced, external designs are diversified, and the airflow rate is secured through the optimized structural arrangement.

Furthermore, preventing jamming and malfunctions of components during opening and closing operations enhances the reliability of the opening and closing operations of the grille.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A variable-type grille apparatus comprising:
a housing with a guide hole extending to include a straight section and mounted to a drive motor;
an opening and closing portion provided to be movable along the guide hole in the housing, coupled a guide link, and rotating in response that the guide link moves linearly; and
a rotation portion including a rotation shaft connected to the drive motor and a rotation plate coupled to the rotation shaft;
a guide portion formed in the rotation plate and connected to the guide link, wherein the guide portion extends to be included in an operable range based on a connection point of the guide link.

2. The apparatus of claim 1, wherein the guide portion includes a groove in the rotation plate and the guide link includes a protrusion inserted into the guide portion to move along the guide portion.

3. The apparatus of claim 1, wherein the guide portion extends from an external side to an internal side of the rotation plate.

4. The apparatus of claim 3, wherein an outermost portion of the guide portion in the rotation plate is open to outside thereof.

5. The apparatus of claim 1, wherein the operable range is a range within a predetermined angle on first and second sides of a second reference line orthogonal to a first reference line which represents a direction of a linear movement of the guide link.

6. The apparatus of claim 5, wherein the predetermined angle is set to 45° with respect to the second reference line so that the operable range is set by 90°.

7. The apparatus of claim 1,
wherein the opening and closing portion includes a moving shaft portion to which a panel portion is coupled, and
wherein the moving shaft portion includes:
a first connecting portion to which the guide link is rotatably connected; and
a second connecting portion inserted into the guide hole.

8. The apparatus of claim 7, wherein the second connecting portion is formed at first and second end portions of the moving shaft portion to bend backward from the moving shaft portion so that a connecting position between the first connecting portion and the guide link and an insertion position of the second connecting portion into the guide hole are apart from each other in a front-to-rear direction thereof.

9. The apparatus of claim 7, wherein the second connecting portion includes a moving portion which is linearly aligned with a connecting portion between the first connecting portion and the guide link and a tilting guide portion that bends backward from the moving portion to be inserted into the guide hole.

10. The apparatus of claim 9,
wherein a plurality of guide holes are formed in an upper portion and a lower portion of the housing respectively, and a first portion and a second portion spaced from a first guide outward are provided in the upper and lower portions, and
wherein the guide holes include a first guide hole that extends in a front-to-rear direction in the first portion and into which the moving portion is inserted and a second guide hole that forms a moving path in the second portion and into which the tilting guide portion is inserted.

11. The apparatus of claim 1, wherein the guide hole extends straight from a front toward a rear of the housing and then bends diagonally.

12. The apparatus of claim 1, wherein the guide hole extends diagonally from a front toward a rear of the housing then extends straight.

13. The apparatus of claim 1, wherein the guide hole extends diagonally from a front toward a rear of the housing.

14. The apparatus of claim 1,
wherein the housing includes a plurality of guide holes arranged in a row,
wherein a plurality of opening and closing portions are respectively connected to the guide holes, and
wherein the rotation portion includes a plurality of rotation plates respectively connected to a plurality of guide links of the opening and closing portions.

15. The apparatus of claim 14, wherein a single rotation shaft is coupled to the plurality of rotation plates by passing through the plurality of plates, so that the plurality of rotation plates simultaneously rotate in response that the drive motor operates.

16. The apparatus of claim 14, wherein the plurality of rotation plates are formed so that the respective guide portions include same start and end positions but have different shapes.

17. The apparatus of claim 14, wherein the plurality of rotation plates are formed so that the respective guide portions include same start and end positions but the size decreases or increases overall.
